(19) United States
(12) Patent Application Publication
(10) Pub. No.: US 2004/0264933 A1
(43) Pub. Date: Dec. 30, 2004

(54) Recording apparatus

(75) Inventor: Shinichiro Uno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/848,162

(22) Filed: May 19, 2004

(30) Foreign Application Priority Data
May 22, 2003 (JP) 2003-144971(PAT.)

(51) Int. Cl. H04N 5/781

(52) U.S. Cl. 386/95; 386/125

(57) ABSTRACT

A recording apparatus for recording on a recording medium a moving image file including moving image data and an associated file associated with the moving image file. The recording apparatus creates one directory for each moving image file and stores the each moving image file and the file associated with the each moving image file in the each directory.

### BACKGROUND OF THE INVENTION

1. Field of the Invention

The present invention relates to a recording apparatus, and more particularly to management of a directory for storing information data such as image data and audio data.

2. Related Background Art

Heretofore, in case of recording a file of information data such as image data and audio data on a random access medium, such an information data file is generally stored and recorded in a directory determined by a file system.

In the recording of the information data file, as described in JP 06-78260 A for example, a plurality of kinds of image data is stored in one directory.

However, in case that a file of image data, a file of audio data and additional information associated with the image data, and the like are mixedly stored with other image data files in one directory, the objective image data file and the file associated with the objective image data file must be thus sought out from a large number of files which are stored in the same directory.

Attention must be paid in a case, for example, where the objective image file and the file associated with the objective image file are selected from one medium to be copied to another medium.

### SUMMARY OF THE INVENTION

It is an object of the present invention to solve the above-mentioned problems.

It is another object of the present invention to enable an information data file associated with an image data file, an audio data file, and the like to be readily recognized and selected from among a large number of files.

In order to achieve the above-mentioned objects, according to one aspect of the present invention, a recording apparatus of the present invention includes recording means for recording on a recording medium a moving image file containing moving image data and an associated file associated with the moving image file; and control means for managing a directory structure of the moving image file and the associated file recorded on the recording medium, wherein the control means creates one directory for each moving image file and stores the each moving image file and the file associated with the each moving image file in the one directory.

Objects other than the above objects and features of the present invention will become clear by reading the following detailed description of the preferred embodiments of the invention with reference to the accompanying drawings.

### BRIEF DESCRIPTION OF THE DRAWINGS

FIG. 1 is a block diagram showing a configuration of a video camera to which the present invention is applied;

FIG. 2 is a diagram showing a directory structure according to an embodiment of the present invention;

FIG. 3 is a diagram showing directory management information of a moving image directory;

FIG. 4 is a diagram showing directory management information of a moving image directory;

FIG. 5 is a diagram showing directory management information of an audio directory;

FIG. 6 is a diagram showing directory management information of a playlist directory;

FIG. 7 is a diagram showing files stored in the moving image directory;

FIG. 8 is a diagram showing files stored in the audio image directory;

FIG. 9 is a diagram showing files stored in the playlist directory;

FIG. 10 is a diagram showing files stored in the moving image directory during the recording of the moving image;

FIG. 11 is a diagram showing files stored in the moving image directory after the recording of the moving image;

FIG. 12 is a flow chart showing a processing for checking a moving image directory;

FIG. 13 is a flow chart showing a processing for checking an audio directory; and

FIG. 14 is a flow chart showing a processing for checking a playlist directory.

### DESCRIPTION OF THE PREFERRED EMBODIMENTS

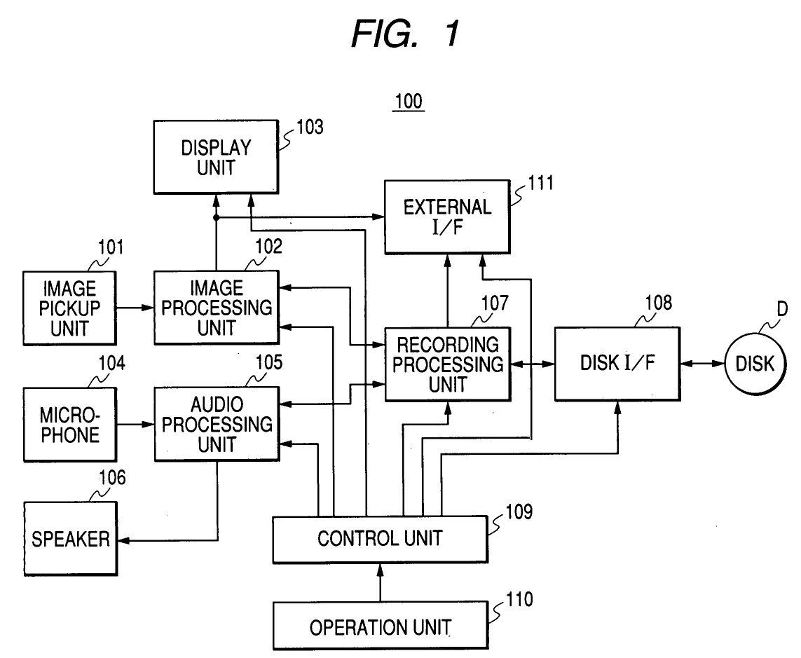

FIG. 1 is a block diagram showing a configuration of a video camera 100 to which the present invention is applied.

The video camera 100 of an embodiment of the present invention can create playlist data showing a procedure for reproducing image data and audio data, in addition to the moving image data and the still image data, and can record and reproduce such data on and from a disk D.

In FIG. 1, upon reception of an instruction to start to photograph a moving image from an operation unit 110, a control unit 109 controls an image processing unit 102 and an audio processing unit 105 to start to photograph a moving image. The image processing unit 102 encodes a digital moving image signal obtained from an image pickup unit 101 in accordance with a well known moving picture experts group (MPEG) method to output the resultant encoded signal to a recording processing unit 107. In addition, a moving image obtained from the image pickup unit 101 is displayed on a display unit 103. Also, the image processing unit 102 creates thumbnail image data associated with the moving image to output the thumbnail image data thus created to the recording processing unit 107. On the other hand, the audio processing unit 105 encodes the digital audio signal outputted through a microphone 104 in accordance with a well known method to output the encoded signal to the recording processing unit 107.

The recording processing unit 107 multiplexes the encoded moving image data and audio data to create a moving image data file to output the moving image data file thus created to a disk I/F 108. In addition, the recording processing unit 107 forms a thumbnail file using the thumbnail image data outputted from the image processing unit 102 to output the thumbnail file thus formed to the disk I/F 108.

The control unit 109 includes a file system driver and an application program. The file system driver checks on a space area on the disk D and a recording position of the file, and issues an instruction to read out/write data from/onto the disk D to the disk I/F 108. In addition, this file system driver, as will be described later, constitutes directories on the disk D, and controls a processing for writing/reading out a file to/from the directories in accordance with the directory structure.

Also, the control unit 109 controls a file forming processing, a file recording processing, a file editing processing, and the like in accordance with the application program.

Also, the control unit 109, as will be described later, creates a management file and a playlist file which are to be stored together with the image data in the directories, and outputs the management file and the playlist file to the disk I/F 108.

The disk I/F 108 includes an optical pickup and a magnetic head for writing/reading out data onto/from the disk D, a mechanism for driving the disk D, and the like. The disk I/F 108 writes data of files such as a moving image file, a management file and a playlist file to specified addresses on the disk D in accordance with an instruction issued from the control unit 109.

The control unit 109 creates a management file which will be described later, in accordance with an instruction to record the moving image data and the audio data on the disk D and outputs the management file thus created to the disk I/F 108. In addition, in this embodiment, a procedure for reproducing the moving image file and the audio file recorded on the disk D can be freely set by manipulating the operation unit 110. Then, the control unit 109 creates a playlist describing the set reproducing procedure. The control unit 109 creates a playlist file and a management file related to the playlist file in accordance with the application program to output the playlist file and the management file related thereto to the disk I/F 108.

Next, a description will hereinafter be given with respect to directory management, as a feature of this embodiment, managed by a file system driver of the control unit 109.

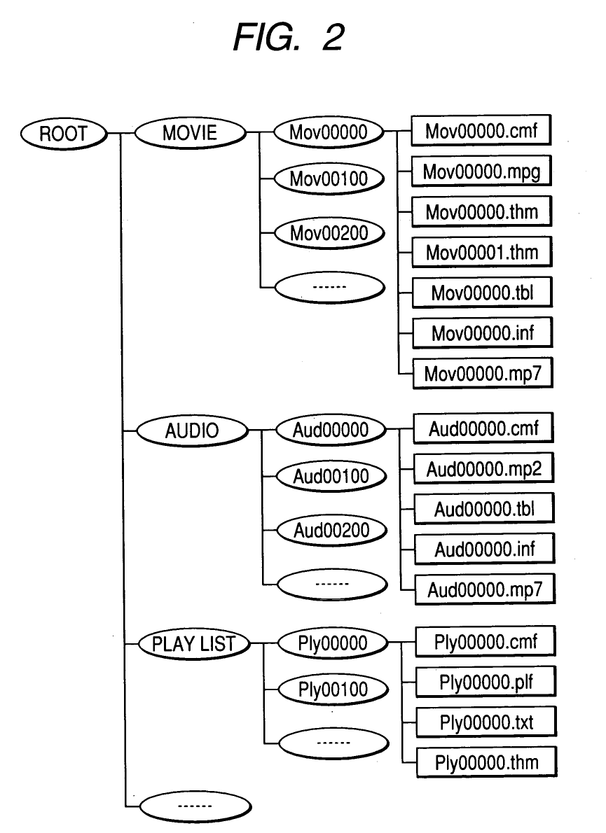

FIG. 2 shows a basic constitution of a directory structure in this embodiment.

In FIG. 2, individual moving image directories each of which is indicated by a name having a character “Mov” and five-finger-number of hexadecimal digit, are arranged at a lower rank of a Movie directory. Then, one moving image file (.mpg) having an extension expressed by “.mpg” is stored in one individual moving image directory. Similarly, individual audio directories each of which is indicated by a name having a character “Aud” and a five-figure-number of hexadecimal digit, are arranged at a lower rank of an Audio directory. Then, one audio file (.mp2) having an extension expressed by “.mp2” is stored in one individual audio directory. In addition, individual playlist directories each of which is indicated by a name having a character “Ply” and a five-figure-number of hexadecimal digit, are arranged at a low rank of a PlayList directory. Then, one playlist file (.plf) is stored in one playlist directory.

The playlist data is used to specify a procedure for reproducing the moving image data and the audio data. In this embodiment, a moving image file, an audio file and a playlist file will hereinafter be collectively referred to as “a moving image audio file” for short. An associated file of each moving image audio file is indicated by the same name with a different extension. In the drawings, the extension of a thumbnail file is expressed by “.thm” and that of a stream information file is expressed by “.inf”.

As shown in FIG. 2, a name of each moving image audio file stored in the same directory is expressed by adding an extension to a name of the individual moving image audio directory having a file stored therein.

Within the individual moving image audio directory, there are also stored a file group associated with the moving image audio file stored in the directory concerned. In each directory, there is stored a directory management file (.cmf) for managing the files stored in the directory concerned. The directory management file will be described in detail later.

In addition thereto, in case of the moving image file, the thumbnail file (.thm), a time map information file (.tb1), a stream information file (.inf), a metadata file (.mp7) and the like are stored therein as the associated files. In case of the audio file as well, similarly to the case of the moving image file, a time map information file (.tb1), a stream information file (.inf), a metadata file (.mp7) and the like are stored therein as the associated files. In case of the playlist file, a text file (.txt) used in the playlist, a thumbnail file (.thm) used when the playlist is displayed, and the like are stored therein as the associated files.

The time map table means a conversion table for conversion between a period of time for reproduction (seconds) from the head of a stream, and a data size (bytes). The time map table is used when the reproduction is made from the middle of a stream, or used for special reproduction or the like. Outline information of a stream such as the date and time of stream formation, data related to a period of time for reproduction, a bit rate and an aspect ratio of the stream is contained in the stream information file. The metadata file is an option, and contains camera data related to zooming, light exposure and the like, producer information and the like. A plurality of thumbnail files can be stored in one directory. In the thumbnail file, the lower two figures of a hexadecimal digit part are changed. That is to say, 256 thumbnail files can be added at maximum with respect to one moving image file or playlist file. Information indicating which parts of the moving image data these thumbnails point, respectively, is described in a directory management file which will be described later.

When the moving image audio file is added, the individual moving image audio directory is simultaneously added, and a necessary associated file group is stored in the same directory. The name of the added individual moving image audio directory is arranged so that the upper three figures of a hexadecimal digit part of the directory are changed, and hence the directories can be created up to 4,096. If it is desired to create more than 4,096 directories, three alphabetical characters from the head of the name of the individual moving image audio directory might be changed.

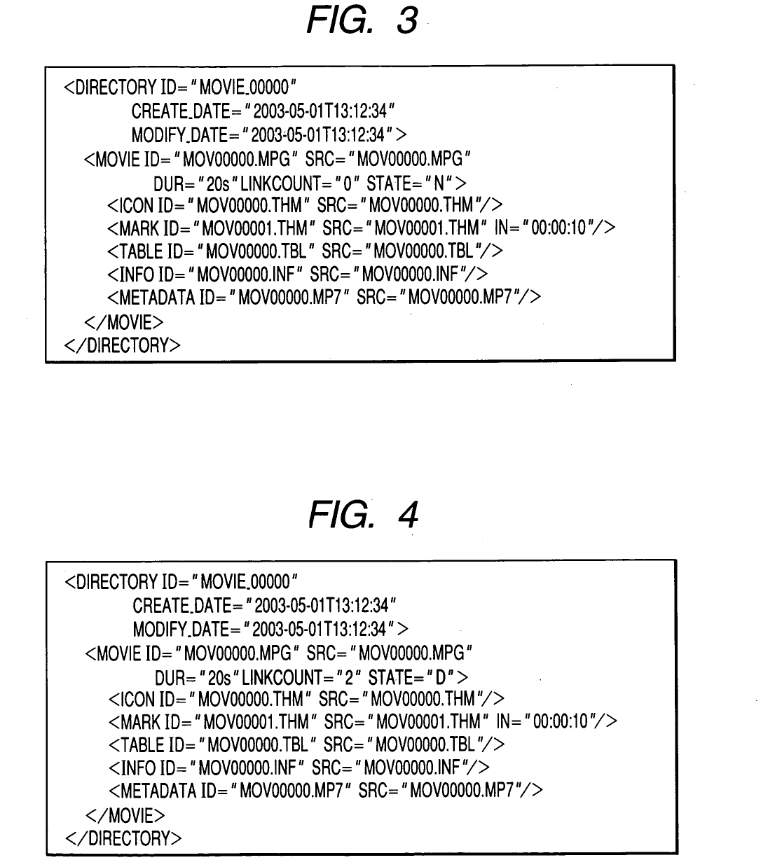

Subsequently, a description will hereinafter be given with respect to the directory management file (.cmf) stored in each directory. FIG. 3 shows an example of a moving image directory management file in case of the directory structure shown in FIG. 2.

The directory management file is described in a format of an extensible markup language (XML). As shown in FIG. 3, the whole directory management file is sandwiched between DIRECTORY elements indicating a directory. A MOVIE element indicating moving image data is arranged therein as a contents element indicating a contents file related to a moving image, a voice and the like, stored in this directory. The associated file is further registered as a parameter element in the MOVIE element.

The thumbnail representing the stream is expressed by an ICON element, and the thumbnail as a marker in the stream is expressed by a MARK element. Also, the time map information file, the stream information file, and the metadata file are expressed by a TABLE element, an INFO element and a METADATA element, respectively.

An ID is added as an attribute to each element. The ID attribute is a unique value within the directory. Thus, when the file system driver or the playlist file refers to a file within each directory, the file system driver or the playlist file specifies the file with not a file name, but the value of ID.

In addition, an actual file name is described as a value of an SRC in the contents element and the parameter element. The date and time of creation and that of modification are described as the attributes in the form of CREATE_DATE and MODIFY_DATE in the DIRECTORY element, respectively.

An attribute DUR indicating a period of time for reproduction is described in the MOVIE element. In addition to the attribute DUR, a link count attribute LINKCOUNT and a state attribute STATE are added in the MOVIE element. The link count attribute LINKCOUNT in the MOVIE element indicates the number of playlist files which refer to the image file stored in the directory concerned. In addition, the state attribute STATE indicates a state of a corresponding file. Its value is expressed by “N” in a normal state, “R” in a read only state, and “D” in a deleted state, respectively.

The meaning of the deleted state D will hereinafter be described.

When an image file and an audio file are deleted from the disk D, a case where a value of the link count is not zero as shown in FIG. 4 means that these files concerned are referred by the playlist. Then, even when the corresponding image file and audio file are deleted, no management file is deleted, and “D” is added as a deletion attribution value. As a result, when the reproduction is made in accordance with the playlist, a reproduction system can recognize that the image file and the audio file corresponding to that management file have already been deleted, and some other action can also be made during the reproduction.

Note that when an instruction to delete a file is issued, if a LINKCOUNT value within the management file is zero, or if the number of files referred by the playlist is reduced to zero, the directory storing the management file therein may be deleted.

In addition, a corresponding period of time within the stream is indicated as an attribute value by IN in a MARK element. The MARK element is mainly used as a marker.

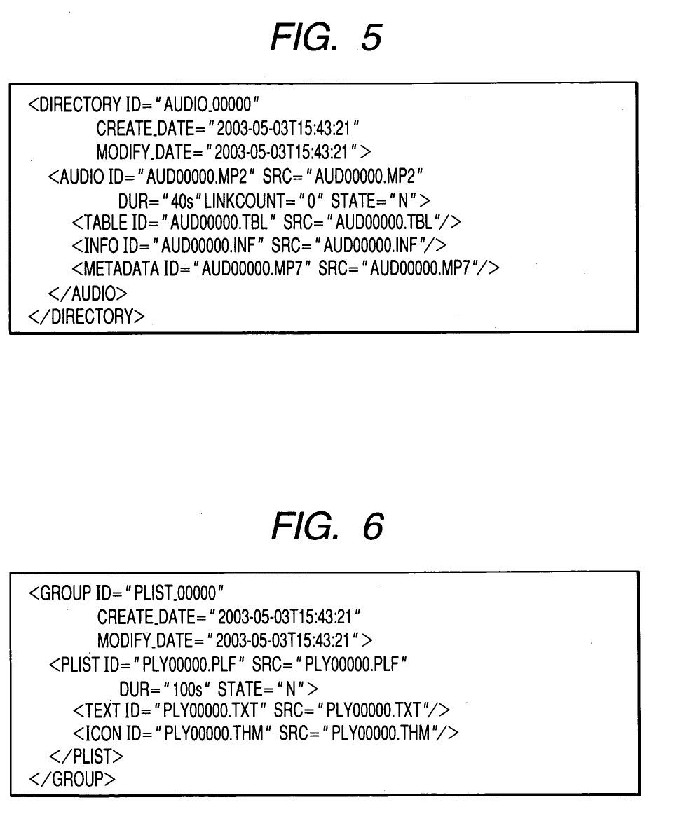

FIG. 5 shows an example of an audio directory management file in case of the directory structure shown in FIG. 2.

While both the elements and the attribute values in FIG. 5 are the same as those in case of the moving image directory management file, an AUDIO element indicating audio data is used as the contents element, and no thumbnail file is registered.

In addition, FIG. 6 shows an example of a playlist directory management file in case of the directory structure shown in FIG. 2.

While this case is also the same as that of the moving image directory management file, a PLIST element indicating playlist data is used as the contents element, and a TEXT element indicating a text file is used as the parameter element. Note that the PLIST element has no link count attribute value.

Subsequently, a description will hereinafter be given with respect to other associated files stored in each individual moving image audio directory.

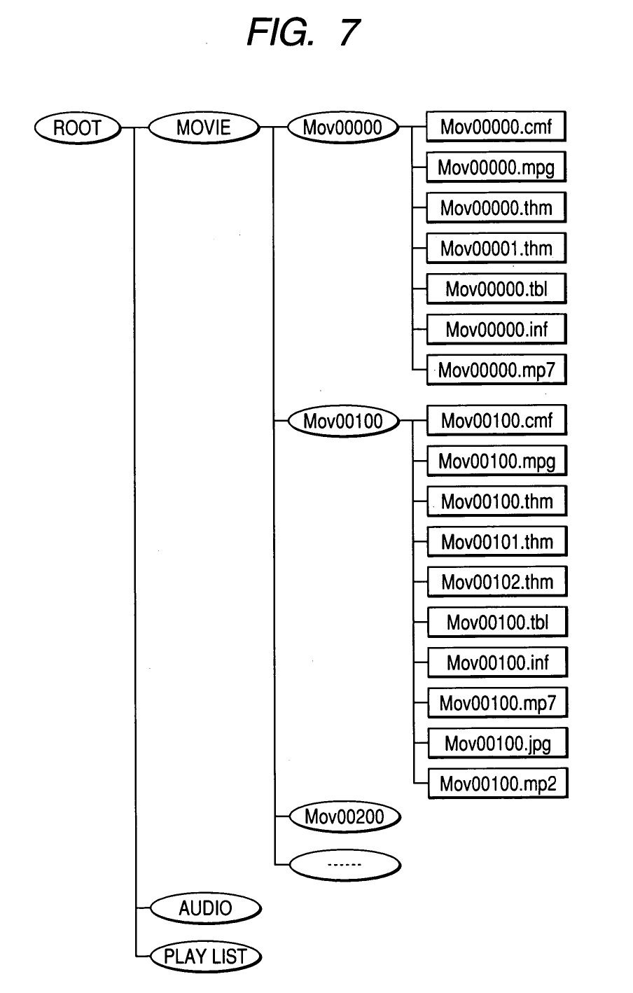

FIG. 7 shows an example of a directory structure of the moving image data.

A file group stored in a Mov00000 directory is the same as that shown in FIG. 2. Then, a third thumbnail file (Mov00102.thm), one still image file (Mov00100.jpg), and one audio file (Mov00100.mp2) are additionally stored in a Mov00100 directory. The thumbnail is created as a marker for a stream. A still image is obtained through the cutting-down from the stream, and a voice is used for after-recording.

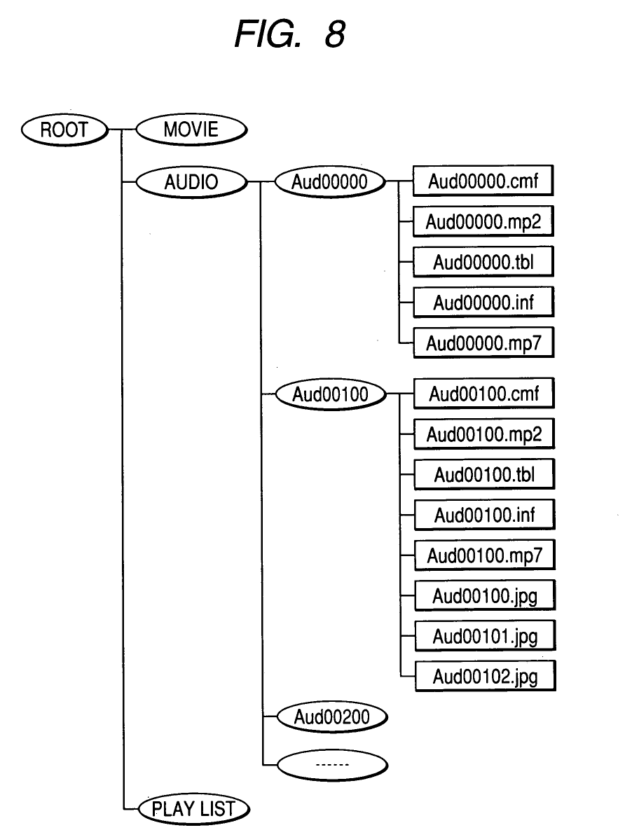

FIG. 8 shows an example of the directory structure of the audio data.

A file group stored in Aud00000 directory is the same as that shown in FIG. 2. Then, three still image files (Aud000100.jpg, Aud00101.jpg and Aud00102.jpg) are additionally stored in the Aud00100 directory. These still image files, for example, are still image data which is obtained through the photographing during the recording of the audio data.

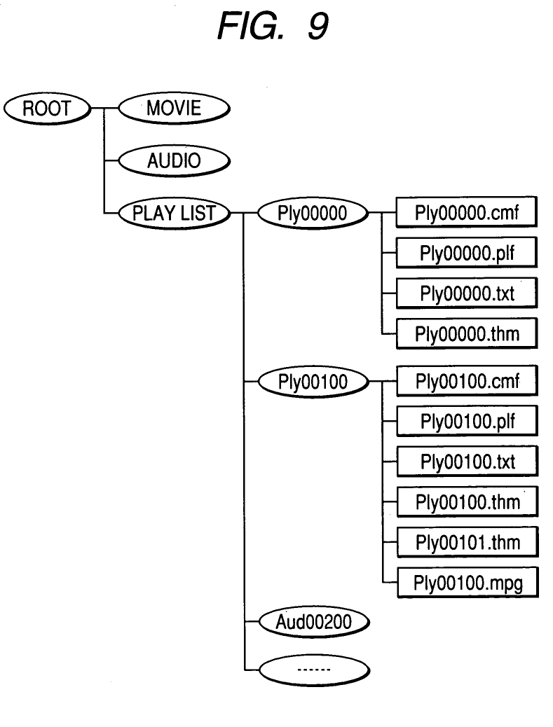

FIG. 9 shows an example of the directory structure of the playlist data.

A file group stored in a Ply00000 directory is the same as that shown in FIG. 2. Then, a second thumbnail file (Ply00101.thm), and a moving image file (Ply00100.mpg) are additionally stored in a Ply00100 directory. The thumbnail is created as a marker within the playlist. The moving image file indicates a file for an effect such as a transition effect or a filter, which is created for a playlist.

Next, a description will hereinafter be given with respect to management of the directory accompanying the recording of the moving image data.

In this embodiment, after start of the recording of the moving image, the moving image data is divided for each fixed period of time into a plurality of files to be stored in one directory. Upon issue of an instruction to stop to record the moving image, a plurality of the moving image files stored in the one directory are combined with one another on the file system to be stored in the form of one file.

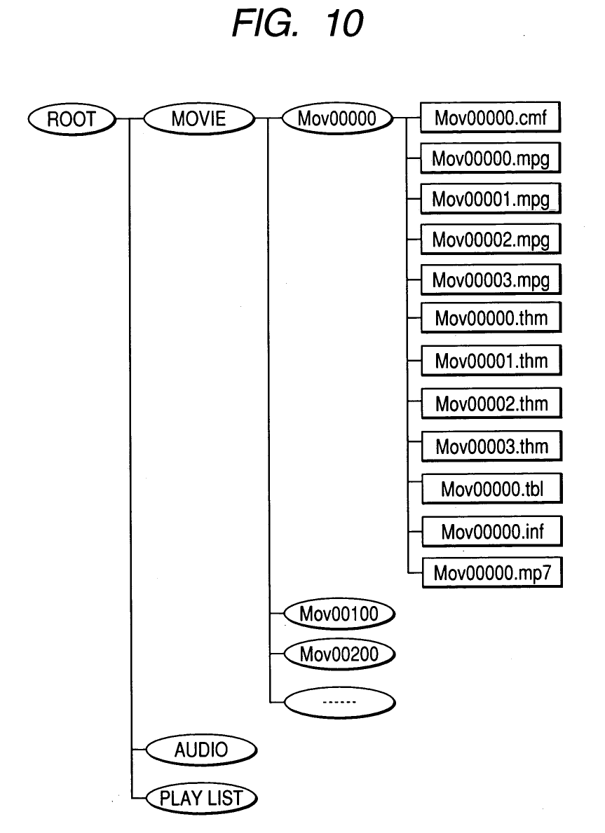

FIG. 10 shows a directory structure in the middle of recording of the moving image file Mov00000.mpg.

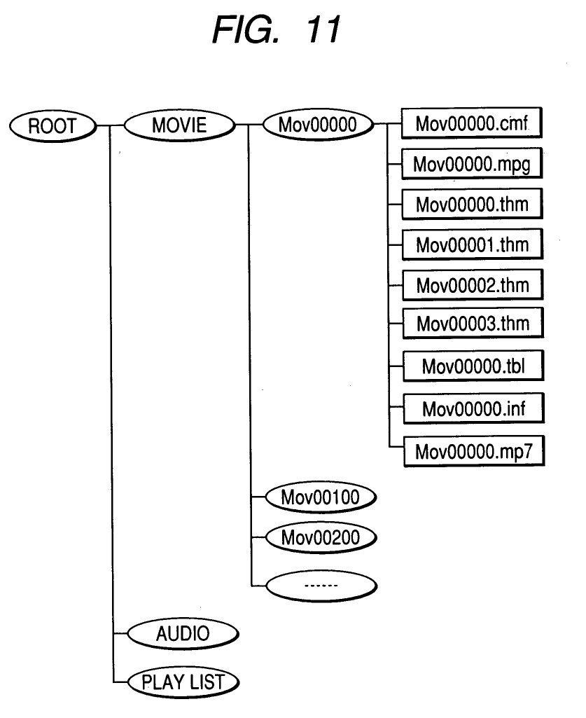

In FIG. 10, four moving image files (.mpg) and four thumbnail files (.thm) are stored in the Mov00000 directory. If an instruction to stop recording the moving image is issued in this state, then the control unit 109 combines these four moving image files with one another on the file system to store the resultant file in the form of one moving image file as shown in FIG. 11.

Note that while in FIG. 10, the thumbnail file is also created for each fixed period of time, no thumbnail needs to be created if unnecessary. In addition, when the moving image files are combined with one another, a plurality of the thumbnail files created as the markers are left as they are.

In such a manner, the moving image data is stored in the same directory while it is divided into a plurality of files for each fixed period of time, whereby even if the recording is not normally completed during the photographing of the moving image due to battery death or the like, the data just before the battery death or the like can be saved. The presence of a plurality of moving image files in the individual moving image directory within the disk D during the reproduction shows that the recording could not be normally completed. Thus, a plurality of the moving image files have to be combined into one file on the file system by the file system driver of the control unit 109.

As described above, in this embodiment, only 256 moving image files can be stored at maximum in one moving image directory. Hence, in case of the recording for a long period of time in which the number of moving image files exceeds 256, directories have to be newly created, and the moving image data has to be distributed among a plurality of directories to be recorded therein. In this case, similarly, thumbnail files and a management file are newly created and stored in each directory, associated with the moving image data stored therein.

In addition, in a case where a period of time from issuing of an instruction to stop recording the moving image to issuing of an instruction to start to record the next moving image is shorter than a predetermined period of time, e.g., the period of time is such a short period of time as to be several minutes, the two moving image data may be recorded in the form of one file instead of recording series of moving image data from a recording start to a recording stop.

Next, a processing during the reproduction will hereinafter be described.

Upon issue of an instruction for a reproduction mode from the operation unit 110, the file system driver in the control unit 109 controls the disk I/F 108 so as to read out the management files of the moving image directories on the disk D. Then, the thumbnail files stored in the moving image directories are reproduced on the basis of the management files to be outputted to the recording processing unit 107.

The recording processing unit 107 outputs these thumbnail file data to the image processing unit 102. The image processing unit 102 creates a thumbnail list picture in accordance with an instruction issued from the control unit 109 to display the thumbnail list picture on the display unit 103.

A user verifies the thumbnail list picture to select the thumbnail corresponding to an arbitrary moving image by manipulating the operation unit 110. The control unit 109 controls the disk I/F 108 so as to read out the moving image files stored in the same directory from the disk D on the basis of the management file corresponding to the selected thumbnail file to output the moving image files thus read out to the recording processing unit 107.

The recording processing unit 107 separates encoded moving image data and encoded audio data from the reproduced moving image files to output the encoded moving image data and the encoded audio data to the image processing unit 102 and the audio processing unit 105, respectively. The image processing unit 102 decodes the reproduced encoded moving image data to output the resultant data to the display unit 103 to display the reproduced moving image. In addition, the audio processing unit 105 decodes the reproduced encoded audio data to output the resultant data to the speaker 106 to output the reproduced sound.

In addition, the image processing unit 102 and the audio processing unit 105 can output the decoded moving image signal and the decoded audio signal to the outside of the recording apparatus through the external I/F 111, respectively.

Next, a description will hereinafter be given with respect to a processing for transferring (copying) the moving image file from the disk D.

When a storage device such as a PC is connected to the recording apparatus through the external I/F 111 and a transfer mode for a file is instructed by manipulating the operation unit 110, the file system driver of the control unit 109 controls the disk I/F 108 so as to read out the management file of each moving image directory on the disk D. Then, the thumbnail file stored in each moving image directory is reproduced on the basis of that management file to be outputted to the recording processing unit 107.

The recording processing unit 107 outputs the thumbnail file data to the image processing unit 102. The image processing unit 102 creates a thumbnail list picture in accordance with an instruction issued from the control unit 109 to display the thumbnail list picture on the display unit 103.

A user verifies the thumbnail list picture to select the thumbnail corresponding to an arbitrary moving image to be transmitted by manipulating the operation unit 110. The control unit 109 controls the disk I/F 108 so as to read out all of the files stored in the same directory from the disk D on the basis of the management file corresponding to the selected thumbnail file to output the files thus read out to the recording processing unit 107.

The recording processing unit 107 successively transmits the reproduced file data to the external I/F 111. The external I/F 111 transmits the files outputted from the recording processing unit 107 to an external storage device according to a format for a transmission line.

In such a manner, according to this embodiment, when the moving image file is copied to an external storage device, all the associated files stored in the same directory are automatically read out from the disk D on the basis of the management file to be transmitted to the external storage device. Hence, a user does not need to find out the file associated with the moving image file which he/she wants to copy from a large number of files recorded on the disk D and thus can transmit the data up to the associated file very simply.

Next, a description will hereinafter be given with respect to a processing in a case where the specified moving image file and the essential associated file are not stored in the individual moving image audio directory when reproduction or file transfer is performed.

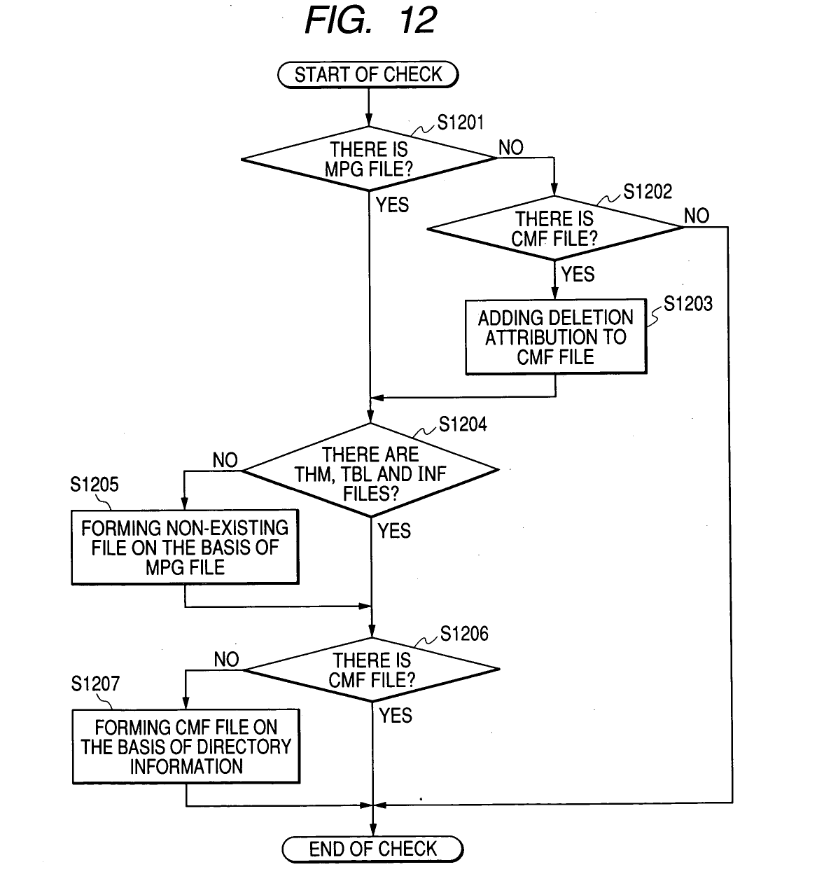

FIG. 12 is a flow chart showing a check processing for the moving image directory processed by the control unit 109.

First of all, it is checked whether or not there is a moving image file body (MPG file) (S1201). If it is checked in S1201 that there is no moving image file, then it is detected whether or not there is a management file (CMF file) (S1202). If it is detected in S1202 that the management file exists, there is a possibility that the management file may be referred from the playlist, and therefore a deletion attribution is added to the management file (CMF file) (S1203). If it is judged that neither the moving image file nor the directory management file is present, then both the moving image file and the directory management file are regarded as being completely deleted, and the processing may be exited without doing anything.

Next, it is checked whether or not there are associated files (THM, TBL and INF files) other than the directory management file (S1204). If not, then the associated files which are judged to be absent are reconstructed by utilizing the moving image file (S1205). Finally, it is checked whether or not the directory management file (CMF file) exists (S1206). If not, a management file is formed with respect to the files stored in the directory (S1207).

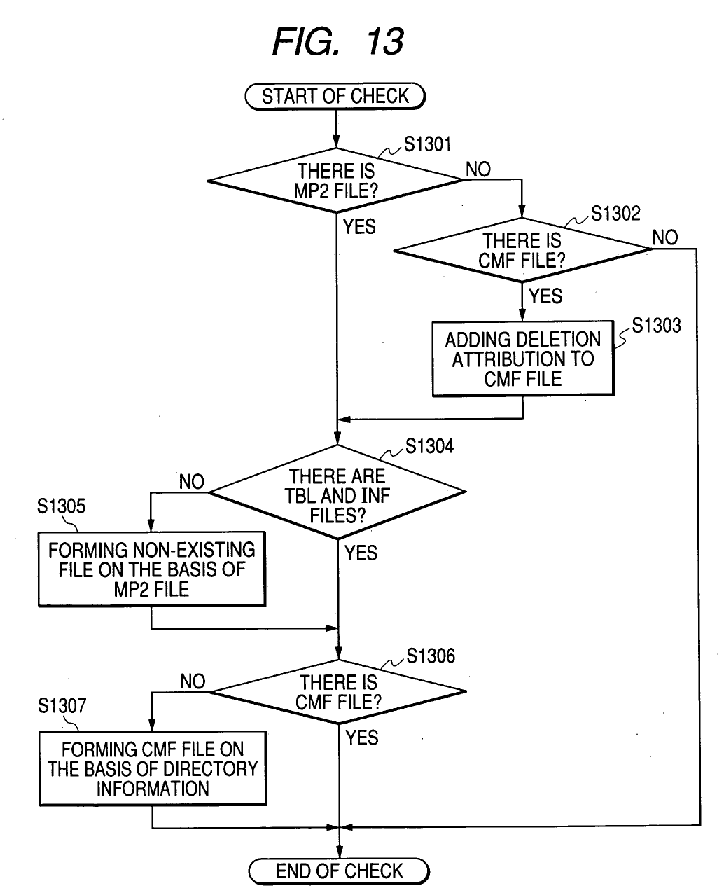

FIG. 13 is a flow chart showing a check processing for the audio directory.

First of all, it is checked whether or not there is an audio file body (MP2 file) (S1301). If it is checked in S1301 that there is no moving image file, then it is detected whether or not there is a management file (CMF file) (S1302). If it is checked in S1302 that the management file exists, there is a possibility that the management file may be referred from the playlist, and therefore a deletion attribution is added to the management file (CMF file) (S1303). If it is judged that neither the audio file nor the directory management file is present, then both the audio file and the directory management file are regarded as being completely deleted, and the processing may be exited without doing anything.

Next, it is checked whether or not there are associated files (TBL and INF files) other than the directory management file (S1304). If not, then the associated files which are judged to be absent are reconstructed by utilizing the audio file (S1305). Finally, it is checked whether or not there is a directory management file (CMF file) (S1306). If not, then the management file is formed with respect to the files stored in the directory (S1307).

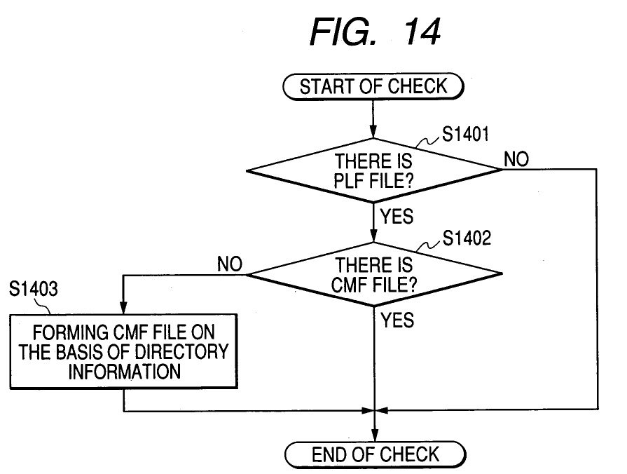

FIG. 14 is a flow chart showing a check processing for the playlist directory.

First of all, it is checked whether or not there is a playlist file body (PLF file) (S1401). If it is checked in S1401 that there is no playlist file, then the processing may be exited without doing anything. Next, it is checked whether or not there is a directory management file (CMF file) (S1402). If not, then the management file is formed with respect to the files stored in the directory (S1403).

Note that while in the above-mentioned embodiment, the description is made by giving as an example the specific case where the disk medium is used as a recording medium, any of media may be adopted as long as it has a structure to store and record an image file and an audio file in a directory.

In addition, the present invention can be applied, for example, to a system including a plurality of devices and apparatuses such as a host computer, an interface device, a reader and a printer, or to a machine or equipment (e.g., a machine or equipment such as a copying machine or facsimile equipment) including one apparatus.

In addition, the objects of the present invention are also attained by supplying a storage medium storing therein a program code of software for implementing the function of the above-mentioned embodiment to a system or an apparatus to read out and execute the program code stored in the storage medium by a computer (or a CPU or an MPU) of the system or apparatus.

In this case, the program code itself read out from the storage medium implements the function of the embodiment, and hence the storage medium storing therein the program code and the program code concerned constitute the present invention.

As for the recording medium for supplying the program code, there may be used a ROM, a flexible disk, a hard disk, an optical disk, a magneto-optical disk, a CD-ROM, a CD-R, a magnetic tape, a nonvolatile memory card or the like.

In addition, the present invention includes also the case where not only the function of the embodiment is implemented by executing the read-out program by the computer, but also an operating system (OS) or the like running on the computer executes a part of or all of an actual processing in accordance with an instruction indicated by the program code, and the function of the embodiment is implemented on the basis of this processing.

Moreover, the present invention includes also the case where after the program code read out from the storage medium is written to a memory provided in a function extended board inserted into the computer or in a function extended unit connected to the computer, a CPU or the like provided in the function extended board or the function extended unit executes a part of or all of an actual processing, and the function of the embodiment is implemented on the basis of this processing.

Many widely different embodiments of the present invention may be constructed without departing from the spirit and scope of the present invention. It should be understood that the present invention is not limited to the specific embodiments described in the specification, except as defined in the appended claims.

What is claimed is:

1. A recording apparatus comprising:
recording means for recording on a recording medium a moving image file including moving image data and an associated file associated with the moving image file; and
control means for managing a directory structure of the moving image file and the associated file recorded on the recording medium,
wherein the control means creates one directory for each moving image file and stores the each moving image file and the file associated with the each moving image file in the one directory.

2. An apparatus according to claim 1, wherein the associated file includes a directory management file indicating information related to a plurality of files stored in the one directory.

3. An apparatus according to claim 2, wherein the directory management file includes deletion information indicating whether or not the moving image file is deleted from the recording medium.

4. An apparatus according to claim 3, wherein the control means detects whether or not the moving image file is stored in a directory on the recording medium, and when the moving image file is not stored in the directory, changes a value of a deletion attribution of the directory management file into a value indicating that the moving image file has been deleted.

5. An apparatus according to claim 3, wherein the recording means further records on the recording medium a playlist file including playlist data indicating a procedure for reproducing the moving image data, wherein the directory management file includes link count information indicating a number of playlist files specifying the moving image file, and wherein the control means deletes, when a value of the link count information is equal to or larger than 1, the moving image file in accordance with a deletion instruction and changes a value of the deletion attribution of the directory management file into a value indicating that the moving image file has been deleted.

6. An apparatus according to claim 2, wherein the directory management file includes reproduction time information indicating reproduction time of the moving image data.

7. An apparatus according to claim 2, wherein the directory management file includes a file element indicating IDs and file names of the moving image file and a plurality of the associated files stored in the one directory.

8. An apparatus according to claim 2, wherein the control means detects whether or not the directory management information is stored in a directory on the recording medium, and when the directory management information is not stored, creates the directory management file based on the moving image file and the associated file stored in the same directory.

9. An apparatus according to claim 1, wherein the associated file includes a representative image file having representative image data related to the moving image data.

10. An apparatus according to claim 1, wherein the associated file includes a stream information file indicating a date and time of creation, a period of time for reproduction, a bit rate, and an aspect ratio of the moving image data.

11. An apparatus according to claim 1, wherein the associated file includes a time map file indicating correspondence between a reproduction position and an amount of data in the moving image data.

12. An apparatus according to claim 1, wherein the associated file includes a metadata file related to the moving image data.

13. An apparatus according to claim 1, wherein whenever an instruction to start recording of the moving image data is issued, the control means newly creates a directory to store the moving image file and the associated file in the newly created directory.

14. An apparatus according to claim 1, wherein when the associated file is not stored in the directory, the control means controls the recording means so as to newly create the associated file to store the newly created associated file in the directory, and to write the newly created associated file into the recording medium.

15. An apparatus according to claim 1, wherein the control means controls the recording means so as to record a series of the moving image data obtained for a period of time from issuing of an instruction to start recording to issuing of an instruction to stop recording, in a form of one file on the recording medium.

16. An apparatus according to claim 15, wherein while the moving image data is recorded, the control means stores a plurality of division data, which are obtained by dividing the moving image data for each fixed period of time, in a form of temporary files in one directory, and combines the plurality of temporary files into one file in accordance with the instruction to stop recording and stores the one file in the one directory.

17. An apparatus according to claim 1, wherein when the moving image data is to be continuously recorded for a period of time equal to or longer than a predetermined period of time, the control means divides the moving image data into a plurality of parts, and stores the divided moving image data and the associated file of the divided moving image data, each in a form of one file, in different directories.

18. An apparatus according to claim 1, further comprising:
reproduction means for reproducing the moving image file and associated file thereof from the recording medium; and
output means for outputting data reproduced by the reproduction means to an outside of the apparatus,
wherein the control means further controls the reproduction means so as to reproduce the associated file together with the moving image file stored in the one directory in accordance with an instruction to copy the moving image file to an external storage unit, and controls the output means so as to output the reproduced moving image file and the associated file to the external storage unit.

19. An apparatus according to claim 18, wherein a plurality of the moving image files are recorded on the recording medium, and the control means controls the reproduction means and the output means so as to reproduce and output one moving image file, which is selected from among the plurality of moving image files, and its associated file.

20. A recording apparatus, comprising:
recording means for recording on a recording medium information file including a moving image file and a playlist file indicating a procedure for reproducing the moving image file, and an associated file associated with the playlist file; and
control means for managing a directory structure of the information file and its associated file recorded on the recording medium,
wherein the control means creates one directory for each playlist file, and stores the each playlist file and its associated file in the each directory.

21. An apparatus according to claim 20, wherein the associated file includes a text file having text data referred to by the playlist file.

22. An apparatus according to claim 20, wherein the associated file includes a representative image file indicating a representative image of the playlist.

23. A recording method comprising:
a recording step of recording on a recording medium a moving image file including moving image data and an associated file associated with the moving image file; and
a controlling step of managing a directory structure of the moving image file and the associated file recorded on the recording medium,
wherein the controlling step includes creating one directory for each moving image file and storing the each moving image file and the file associated with the one moving image file in the each directory.

24. A recording method comprising:
a recording step of recording on a recording medium information file including a moving image file and a playlist file indicating a procedure for reproducing the moving image file, and an associated file associated with the playlist file; and
a controlling step of managing a directory structure of the information file and its associated file recorded on the recording medium,
wherein the controlling step includes creating one directory for each playlist file, and storing the each playlist file and its associated file in the each directory.
